(19) United States
(12) Patent Application Publication
(10) Pub. No.: US 2010/0023872 A1
(43) Pub. Date: Jan. 28, 2010

(54) WEB PAGE SERVING ARCHITECTURE

(75) Inventor: Keith A. Marlow, Galston (AU)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/181,245

(22) Filed: Jul. 28, 2008

(51) Int. Cl. G06F 3/048

(52) U.S. Cl. 715/745

(57) ABSTRACT

The subject matter disclosed herein relates to presentation of content on web page protocols.

### BACKGROUND

1. Field

The subject matter disclosed herein relates to web page serving protocols.

2. Information

The generation of pages, such as web pages or application pages, for delivery to client devices, may involve a high degree of complexity. Content may be provided to a page on a client device in a number of ways. These include such content as an advertisement, a page header, text or graphic content, or other content. The process of updating of the content, as well as the placement of the content, may require a large investment of time.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of a system that is capable of establishing a session between a client and one or more servers over a network;

FIG. 2 illustrates a web browser as displayed on display device, according to an embodiment; and

FIG. 3 is a block diagram that illustrates a computer system upon which an embodiment may be implemented.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “identifying,” “initiating,” “obtaining,” “hosting,” “maintaining,” “representing,” “modifying,” “receiving,” “transmitting,” “establishing,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine-readable instructions stored in a storage medium. Further, unless specifically stated otherwise, process described herein, with reference to flow diagrams or otherwise, may also be executed and/or controlled, in whole or in part, by such a computing platform.

A “session” as referred to herein relates to a period during which processes communicate over a network to perform one or more tasks, operations and/or functions. In one particular embodiment, a session may be established between a client and a server for the purpose of providing one or more resources and/or services to the client. For example, such a session between a client and server may be established for any one of several communication protocols (e.g., TCP/IP) for the transmission of datagrams and/or packets. In a particular embodiment, such a session may be established according to a particular communication protocol enabled by a network employing network, data link and physical layer protocols for transmission of information between processes according to associated addresses.

As used herein, the terms “module” or “widget”, used interchangeably herein, refers to a computer-based application that communicates, directly or indirectly, with at least one other component across a network to call for content to be selectively displayed. Widgets may comprise interactive virtual tools that may provide single-purpose services such as showing the user the latest news, the current weather, the time, a calendar, a dictionary, a map program, a calculator, desktop notes, photo viewers, among other things.

A party that delivers content over the World Wide Web, such as a website operator, may provide information for presentation to multiple users on websites using modules and or widgets. In one particular embodiment, such a party delivering content may enable a user to customize how, or under what conditions, such content is to appear on the user's computing platform. Here, such a user may be allowed to define a “rule recipe” which sets out how and/or or under what conditions content associated with a module is to be presented to the user on a computing platform.

In a particular implementation, a rule recipe may define attributes such as, for example, layout, formatting, and other parameters that prepare a web page for delivery. Accordingly, a server delivering the web page may be adapted to transform, manipulate and/or format content associated with a module for delivery on a web page according to such a rule recipe. This allows the accommodation of differing specifications of client devices, differing classes of users, and a number of other ways in which content may be customized.

In another embodiment, a user-defined rule recipe may specify how and or when content associated with a module is to be delivered to a user based upon one or more predetermined conditions specified in such a rule recipe. In a particular example, for the purpose of illustration, a module may be associated with local weather conditions and a user-defined rule recipe may specify display of such weather conditions if the conditions are sunny or fair. In another example, a rule recipe may indicate that weather for a particular beach is to be presented upon detection that surf conditions are good. However, these are merely examples of predetermined conditions that may be specified in a rule recipe for determining when module content is to be presented on and/or over laid on a web page, and claimed subject matter is not limited in this respect.

As discussed below, particular embodiments may enable network application developers, advertisers, and content providers to deliver content based, in part, on the module, the rule recipe, and/or user behavior. In other embodiments, such rule recipes may be portable to multiple “properties” and/or personal web pages associated with a user. In yet other embodiments, such rule recipes created and/or modified by multiple users may be maintained in a library that is accessible for use by a community of users. It should be understood, however, that these are merely example embodiments and that claimed subject matter is not limited in this respect.

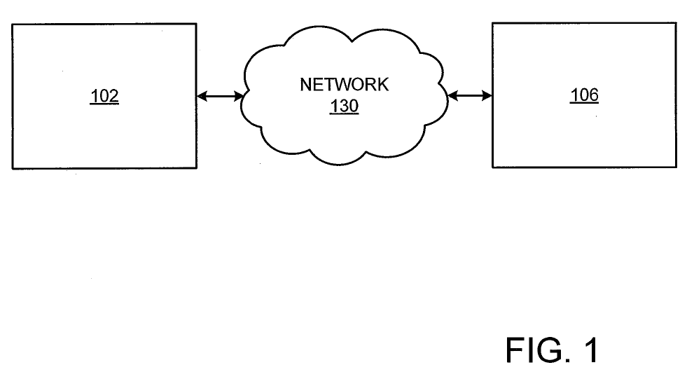

FIG. 1 is a schematic diagram of a system 100 that is capable of establishing a session between a client 102 and one or more servers 106 over a network 130. Network 130 may employ data links (not shown) comprising one or more data transmission mediums such as, for example, cabling (e.g., fiber optic, twisted wire pair, coaxial), satellite transmission links or terrestrial wireless transmission links. However, these are merely examples of data transmission media that may be used for transmitting information in a network and claimed subject matter is not limited in this respect. Additionally, network 130 may employ one or more communication protocols for transmitting information between a source and a destination such as, for example, an Internet Protocol (IP), asynchronous transfer mode (ATM) and/or communication protocols adapted for use on wireless transmission links. However, these are merely examples of communication protocols that may be used for transmitting information between a source and a destination in a network and claimed subject matter is not limited in these respects. In particular embodiments, network 130 may comprise one or more network topologies and/or configurations such as, for example, one or more local area networks, one or more Intranets, the Internet, wireless carrier infrastructure Internet versus Intranet, and/or wireless carrier infrastructure, just to name a few examples. While particular examples provided herein establish a session between a client and server, it should be understood that such implementations are merely examples provided for the purpose of illustration and claimed subject matter is not limited to such implementations. For example, a session may also be established between peer devices and/or processes over network 130.

Client 102 may comprise one or more processes hosted on a computing platform that is communicatively coupled to network 130 by a communication adapter (not shown). Similarly, servers 106 may comprise processes hosted on one or more computing platforms connected to network 130 by an associated communication adapter.

Client 102 may initiate a session with a server 106 to receive a service by, for example, establishing a session through which client 102 and server 106 may communicate over network 130. Client 102 may comprise any one of several application programs hosted on a computing platform such as, for example, email applications, web browsers, document processing programs, media players, and/or the like. Here, it should be understood that client 102 may be hosted and/or executed on any one of several devices capable of communicating with a network such as, for example, personal computers, mobile telephones, personal digital assistants, just to name a few examples.

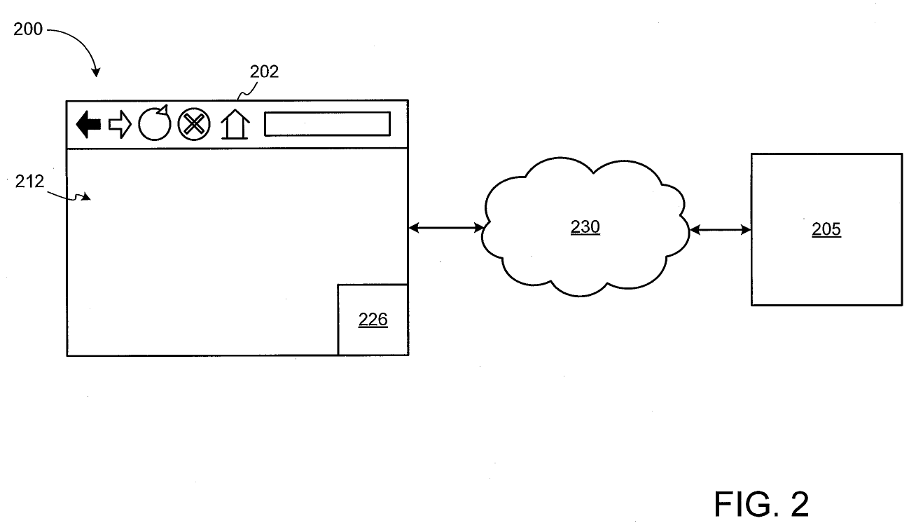

FIG. 2 illustrates web browser 200 as displayed on a display device (not shown) which may be provided as a component of a client computing platform, for example, according to an embodiment. Here, browser 200 may display web page content 212 received in a session with a web server (not shown) over network 230, for example. In one implementation, such a session may be initiated through interaction with a tool bar 202 using a graphical user interface provided by a client computing platform (not shown).

According to an embodiment, module and/or widget content 226 may be presented in and/or overlaid on web page content 212 (e.g., as a pop-up message) according to one or more user-defined rule recipes. Here, content associated with a module may be processed at a rule recipe engine 205 hosted in conjunction with a web server (not shown). In a particular implementation, although claimed subject matter is not limited in this respect, a session with a web server to provide web page content 212 may be associated with a particular user identity and/or information associated with a user client computing platform. Here, such a web server may associate such information with one or more modules and/or user-defined rule recipes to provide module and/or widget content 226 for presentation according to an associated rule recipe. As pointed out above, rule recipes may be portable to multiple properties and/or personal web pages defined by a user.

According to an embodiment, users may define and/or create rule recipes through interaction with a web server. For example, a user may first select a particular module from a library of modules available. Then, the user may specify rules and/or conditions to control presentation of content associated with the selected module on a computing platform (e.g., the user's computing platform). In particular embodiments, a user may have an account with a web server that may be accessed through any one of several computing platforms (e.g., a portable home page) with a web browser capable of establishing a session with the web server. A user may define a rule recipe to specify how and/or when module content is to be presented to the user in a session, regardless of the particular computing platform being used by the user for the session. Also, such a rule recipe may be maintained by a web page service provider in association with a user profile. Here, such a web page service provider may apply such a rule recipe if a user accesses a property and/or web page defined in the user profile.

According to a particular implementation, a web page service provider may apply a rule recipe as an override to a default page layout or “canvas” associated with a module and/or widget. Here, such a rule recipe may be constrained by one or more static dimensions of the module. Subject to such static dimensions, a user may then define, determine, specify and/or select how particular content associated with a module is to be presented and/or overlaid in the users browser. The rule recipe may then be associated with the module in a module map so that the rule recipe may be applied for determining how and/or when associated module content is to be presented to the user.

According to an embodiment, user-defined rule recipes may be stored in a rule recipe library according to index criteria. Such index criteria may include, for example, descriptive text, common sub-expressions, association with particular modules, just to name a few examples. In one implementation, as a rule recipe is created and/or modified, the rule recipe may be indexed in accordance with index criteria into rule recipe associations. Such a rule recipe association may comprise one or more index criteria and one or more rule recipes associated with the one or more index criteria. In one particular implementation, such rule recipe library may be accessible by multiple users to enable sharing of user defined rule recipes. In one embodiment, a user may select a rule recipe from a rule recipe library and further modify the selected rule recipe as desired. The modified rule recipe may then be indexed and added to the rule recipe library as discussed above.

In one particular implementation, a rule recipe library may offer a user a menu of relevant rule recipes associated with a particular module selected by the user, for example. If a user is not interested in rule recipes in the menu, the user may modify one of the rule recipes, and/or create a rule recipe. As pointed out above, in particular embodiments such a rule recipe library may be accessible by multiple users in a community of users that may use and/or modify rule recipes created by other users.

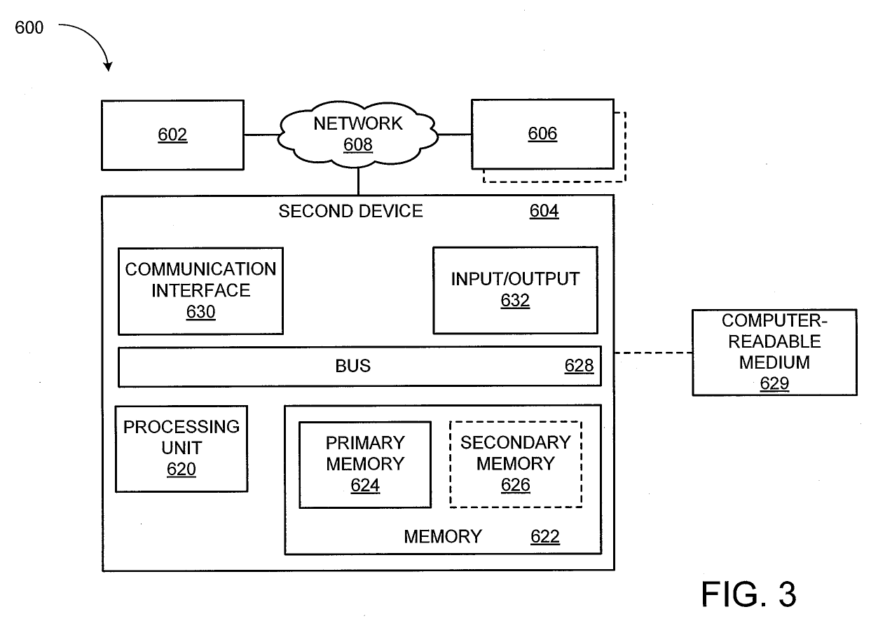

FIG. 3 is a schematic diagram illustrating an exemplary embodiment of a computing environment system 600 that may include one or more devices configurable to act as a client or server computing platform, for example. System 600 may include, for example, a first device 602, a second device 604 and a third device 606, which may be operatively coupled together through a network 608.

First device 602, second device 604 and third device 606, as shown in FIG. 6, may be representative of any device, appliance or machine that may be configurable to exchange data over network 608. By way of example but not limitation, any of first device 602, second device 604, or third device 606 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 608, as shown in FIG. 6, is representative of one or more communication links, processes, and/or resources configurable to support the exchange of data between at least two of first device 602, second device 604, and third device 606. By way of example but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 606, there may be additional like devices operatively coupled to network 608.

It is recognized that all or part of the various devices and networks shown in system 600, and the processes and methods as further described herein, may be implemented using or otherwise include hardware, firmware, software, or any combination thereof.

Thus, by way of example but not limitation, second device 604 may include at least one processing unit 620 that is operatively coupled to a memory 622 through a bus 628.

Processing unit 620 is representative of one or more circuits configurable to perform at least a portion of a data computing procedure or process. By way of example but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 628. Computer-readable medium 628 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 632 may include an operatively configured display, speaker, keyboard, mouse, trackball, touch screen, data port, etc.

With regard to system 600, in certain implementations first device 602 may be configurable, to transmit information regarding an event to second device 604 by providing or otherwise identifying a publication that second device 604 may then process. For example, one such event may relate to any one of several types of published events described above according to particular embodiments. In response to such a publication, for example, second device 604 may then process a stabbing query using one or more techniques illustrated above.

Here, for example, to process such a stabbing query second device may be configured to access stored data associated with various items that may be available within system 600 and which may be of interest or otherwise associated with information included within the stabbing query. The stored data may, for example, one or more trees.

It should also be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Such software and/or firmware may be expressed as machine-readable instructions which are executable by a processor. Likewise, although the claimed subject matter is not limited in scope in this respect, one embodiment may comprise one or more articles, such as a storage medium or storage media. This storage media, such as one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method comprising:
defining one or more modules adapted for delivery of information from a server to one or more client computing platforms; and
enabling users to define rule recipes for customizing presentation of said information to said one or more client computing platforms on a web page.

2. The method of claim 1, wherein at least one rule recipe is based, at least in part on a user-specified canvas defined subject to one or more static dimensions associated with an associated module.

3. The method of claim 1, wherein one or more of said rule recipes are associated with a user profile.

4. The method of claim 1, wherein at least one of said modules is adapted to deliver information to one or more computing platforms in response to a predetermined condition.

5. The method of claim 4, wherein at least one of said rule recipes is adapted to present said delivered information as a pop-up message in a display.

6. The method of claim 1, and further comprising:
maintaining a collection of said user-defined rule recipes in a library; and
enabling users in a community of users to access said rule recipes in said library.

7. The method of claim 6, wherein said maintaining said collection of said user-defined rule recipes comprises indexing said rule recipes based, at least in part, on attributes of modules compatible with said rule recipes.

8. An article comprising:
a storage medium comprising machine-readable instructions which, if executed by a computing platform, are adapted to enable to enable said computing platform to:
define one or more modules adapted for delivery of information from a server to one or more client computing platforms; and
enable users to define rule recipes for customizing presentation of said information to said one or more client computing platforms on a web page.

9. The article of claim 8, wherein at least one rule recipe is based, at least in part on a user-specified canvas defined subject to one or more static dimensions associated with an associated module.

10. The article of claim 8, wherein one or more of said rule recipes are associated with a user profile.

11. The article of claim 8, wherein at least one of said modules is adapted to deliver information to one or more computing platforms in response to a predetermined condition.

12. The article of claim 11, wherein at least one of said rule recipes is adapted to present said delivered information as a pop-up message in a display.

13. The article of claim 8, wherein said instructions, if executed by said computing platform, are further adapted to enable to enable said computing platform to:
maintain a collection of said user-defined rule recipes in a library; and
enable users in a community of users to access said rule recipes in said library.

14. The article of claim 13, wherein said instructions, if executed by said computing platform, are further adapted to enable said computing platform to index said rule recipes based, at least in part, on attributes of modules compatible with said rule recipes.

15. An apparatus comprising:
a computing platform, said computing platform being adapted to:
define one or more modules adapted for delivery of information from a server to one or more client computing platforms; and
enable users to define rule recipes for customizing presentation of said information to said one or more client computing platforms on a web page.

16. The apparatus of claim 15, wherein at least one rule recipe is based, at least in part on a user-specified canvas defined subject to one or more static dimensions associated with an associated module.

17. The apparatus of claim 15, wherein one or more of said rule recipes are associated with a user profile.

18. The apparatus of claim 15, wherein at least one of said modules is adapted to deliver information to one or more computing platforms in response to a predetermined condition.

19. The apparatus of claim 18, wherein at least one of said rule recipes is adapted to present said delivered information as a pop-up message in a display.

20. The apparatus 15, wherein said computing platform is further adapted to:
maintain a collection of said user-defined rule recipes in a library; and
enable users in a community of users to access said rule recipes in said library.
